(19) United States
(12) Patent Application Publication
(10) Pub. No.: US 2025/0085875 A1
(43) Pub. Date: Mar. 13, 2025

(54) DIRECTED REFRESH MANAGEMENT (DRFM) ADDRESS CAPTURE IN HIGH-BANDWIDTH MEMORY (HBM)

(71) Applicants: Advanced Micro Devices, Inc., Santa Clara, CA (US); ATI Technologies ULC, Thornhill (CA)

(72) Inventors: Michael LITT, Ontario (CA); Yubin YAO, Santa Clara, CA (US)

(21) Appl. No.: 18/745,994

(22) Filed: Jun. 17, 2024

Related U.S. Application Data
(60) Provisional application No. 63/537,549, filed on Sep. 10, 2023.

(51) Int. Cl. G06F 3/06

(52) U.S. Cl. CPC G06F 3/0632; G06F 3/0604; G06F 3/0673

(57) ABSTRACT

Examples herein describe techniques for directed refresh management (DRFM) address capture in high-bandwidth memory (HBM). Some examples are based on an activate command that includes a DRFM flag, including examples in which the activate command is received and processed while a bank is open, examples in which an address of a target row is captured without opening the corresponding bank, and examples in which the address of a target row is captured based further on a mode registers. Other examples are based on a precharge command that includes a DRFM flag.

### CROSS REFERENCE TO RELATED APPLICATIONS

This application claims the benefit of U.S. Provisional Patent Application No. 63/537,549, filed Sep. 10, 2023, which is incorporated herein by reference in its entirety.

### BACKGROUND

Many of today's workloads and applications such as AI, data analytics, video transcoding, and genomic analytics require an increasing amount of memory bandwidth. Traditional double data rate (DDR) memory solutions have not been able to keep up with the growing compute and memory bandwidth-intensive workloads are becoming data movement and access bottlenecks. High-bandwidth memory (HBM) helps alleviate this bottleneck. A high-bandwidth memory (HBM) device includes multiple, vertically stacked dynamic random access memory (DRAM) dies, which may be mounted over a high-speed logic layer, and a wide interface (e.g., a 1024-bit interface). The DRAM dies are connected to the high-speed logic layer with through-silicon-vias (TSVs). HBM devices use ultra-wide (e.g., 1024-bit) interface architectures to provide high-bandwidth, high-speed, and low-power operation.

Directed refresh management (DRFM) is a process of refreshing a host-requested row of memory, along with physically adjacent neighboring rows. DRFM is useful for countering the Row Hammer (RH) phenomenon, in which a frequently activated row (aggressor) results in bit-flips in adjacent rows (victims). RH may be incurred when an activation rate of the aggressor exceeds an RH threshold (FlipTH). RH impacts data integrity, and may be abused in various attack scenarios.

DRFM is not available in current HBM devices, and is not addressed in current HBM3 JEDEC standards.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a block diagram of an integrated circuit (IC) device that includes high-bandwidth memory (HBM) having a stack of dynamic random access memory (DRAM) dies, according to an example.

FIG. 2 is a block diagram of a HBM DRAM die stack, according to an example.

FIG. 3 illustrates a timing diagram of row commands and column commands for capturing a row address for a DRFM event based on a DRFM flag of an activate command, according to an example.

FIG. 4 illustrates a timing diagram of row commands and column commands for a situation in which a host decides to capture a row address of an open bank/row, according to an example.

FIG. 5 illustrates a timing diagram in which a HBM DRAM (e.g., a state machine of the HBM DRAM) is designed to process an activate command that contains a set DRFM flag (i.e., DRFM=1), while a target bank/row are open, without having to wait until the target bank/row are closed, according to an example.

FIG. 6 illustrates a timing diagram 600 in which the HBM DRAM is designed to process activate command 302 (i.e., with DRFM=1) while the target bank/row are open, such as described above with reference to FIG. 5, where activate command 302 overlaps with column command 404. according to an example.

FIG. 7 illustrates a timing diagram in which the HBM DRAM is designed to process the activate command (i.e., with DRFM=1), while the target bank/row are closed, without opening the target bank/row, according to an example.

FIG. 8 illustrates an activate command that has a field for a DRFM flag, according to an example.

FIG. 9 illustrates a precharge per-bank command, PREbp, formatted in accordance with a HBM standard.

FIG. 10 illustrates a 2-UI (i.e., single cycle) precharge per-bank command, PREbp_DRFM, that includes a field for a DRFM flag, according to an example.

FIG. 11 is a block diagram of configurable circuitry 1100, including an array of configurable or programmable circuit blocks or tiles, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Examples herein describe techniques for directed refresh management (DRFM) address capture in high-bandwidth memory (HBM).

HBM includes a wide-interface architecture that provides high-bandwidth/high-speed, low power operation to a stack of DRAM dies, across multiple independent interfaces called channels. A channel interface may include a 64-bit data bus operating at double data rate (DDR). In an example, a DRAM stack supports up to 16 channels. Each channel provides access to an independent set of DRAM banks. Requests from one channel may not access data attached to a different channel. The channels may be independently clocked, and need not to be synchronous with one another. A HBM design/device may be designated HBM1, HBM2, HBM3, et cetera, based on applicable specifications.

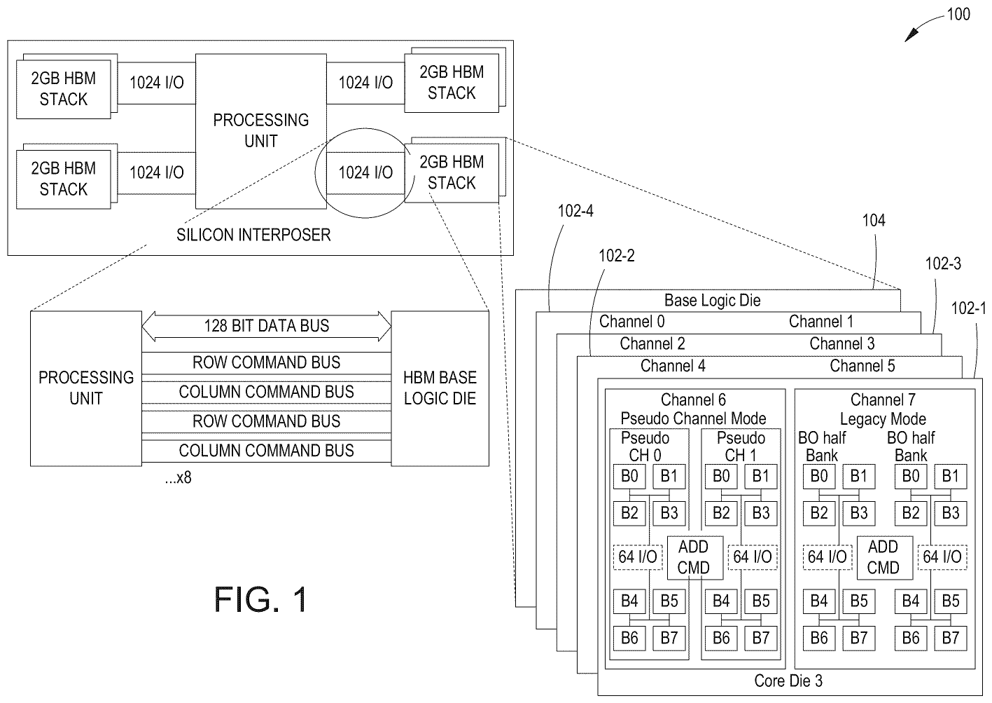

FIG. 1 is a block diagram of an integrated circuit (IC) device 100 that includes HBM having a stack of DRAM dies, illustrated here as 4 DRAM dies 102-1 through 102-1, according to an example.

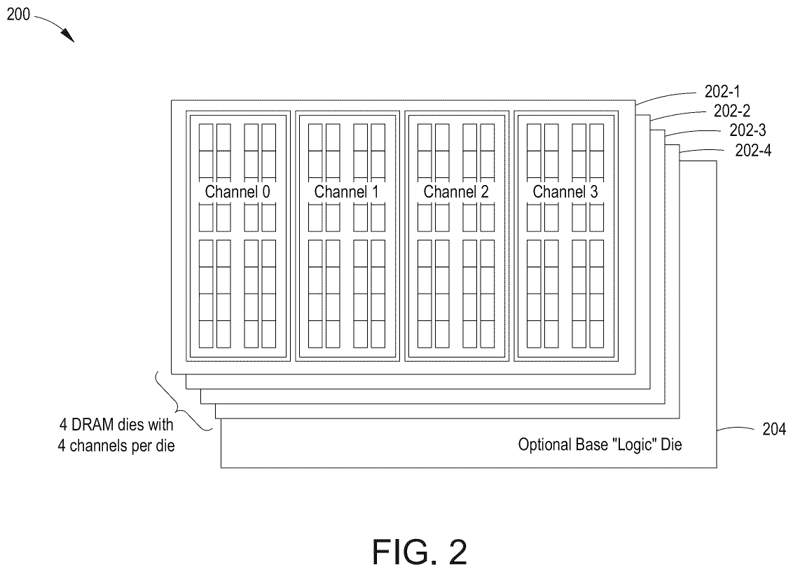

FIG. 2 is a block diagram of a HBM DRAM die stack 200, according to an example. In the example of FIG. 2, DRAM die stack 200 includes 4 DRAM dies 202-1 through 202-4 (collectively, dies 202), where each die 202 supports 4 channels. Dies 202 are not, however, limited to 4 channels. Each die 202 contributes additional capacity and additional channels to stack 200 (e.g., up to 16 channels per stack). Each channel may include an independent command and data interface.

HBM may include semi-independent row and column command interfaces for each channel. The semi-independent interfaces may increase command bandwidth and performance by allowing read and write commands to be issued simultaneously with other commands, such as activate commands and precharge commands.

A HBM DRAM stack may include an interface die (i.e., base logic die 104 and 204 in FIGS. 1 and 2, respectively) that provides signal redistribution and other functions. The interface die may further include DRAM logic that might otherwise be provided on DRAM dies 102 and/or 202.

A HBM DRAM may be operated in a legacy mode or a pseudo channel (PC) mode. PC mode divides a channel into two individual sub-channels (e.g., of 32 bit I/O each, providing 256-bit prefetch per memory read and write access for each pseudo channel). The sub-channels may operate semi-independent of one another (e.g., by sharing a row and column command bus of the channel, and CK and R0 inputs), but may decode and execute commands individually. In legacy mode, the channel is not divided.

HBM DRAM is divided into banks (e.g., 8 to 16 banks). Each bank is divided into rows. The rows may include, for example, 64 columns. In pseudo-channel mode, each column stores, for example, 128 bits of data, and may store associated error code correction (ECC), if supported. In legacy mode, each column stores, for example, 256 bits of data along with ECC, if supported.

In a HBM DRAM device, a typical memory access operation (e.g., read or write) involves an activate command (ACT), followed by a column command (e.g., a read (RD) or write (WR) operation), followed by a precharge (PRE) command. The ACT command instructs the HDM DRAM to open a host-selected (i.e., target) bank/row (e.g., copies data from the target row of memory cells to a buffer). The column command instructs the HDM DRAM to execute the column command on the buffered data from the target row. The PRE command instructs the HDM DRAM to close the target bank/column (e.g., to write the data from the buffer back to the target row of memory cells). HBM devices include separate row and column command buses. Nevertheless, as with any complex circuitry, certain memory access operations/activities need to be separated in time to avoid conflicts. JEDEC HBM standards address timing issues, examples of which are provided further below.

A directed refresh management (DRFM) event may involve refreshing a host-requested row of memory, along with physically adjacent neighboring rows. Although DRFM implementation details may vary by vendor, a DRFM event generally requires a target bank and row address. In other types of DRAM (e.g., DDR5/LPDDR5/GDDR7), a host device may initiate a directed refresh management (DRFM) event by setting a DRFM flag of a precharge per bank (PREpb) command or an auto precharge (AP) command. Under current JEDEC HBM standards, however, there is no room for a DRFM flag in the PREpb command or in WRA/RDA commands.

Techniques for capturing a row address in a HBM DRAM for a DRFM event are disclosed herein. The techniques are designed to minimize hardware re-design efforts, delays, and overhead, and to accommodate other industry concerns.

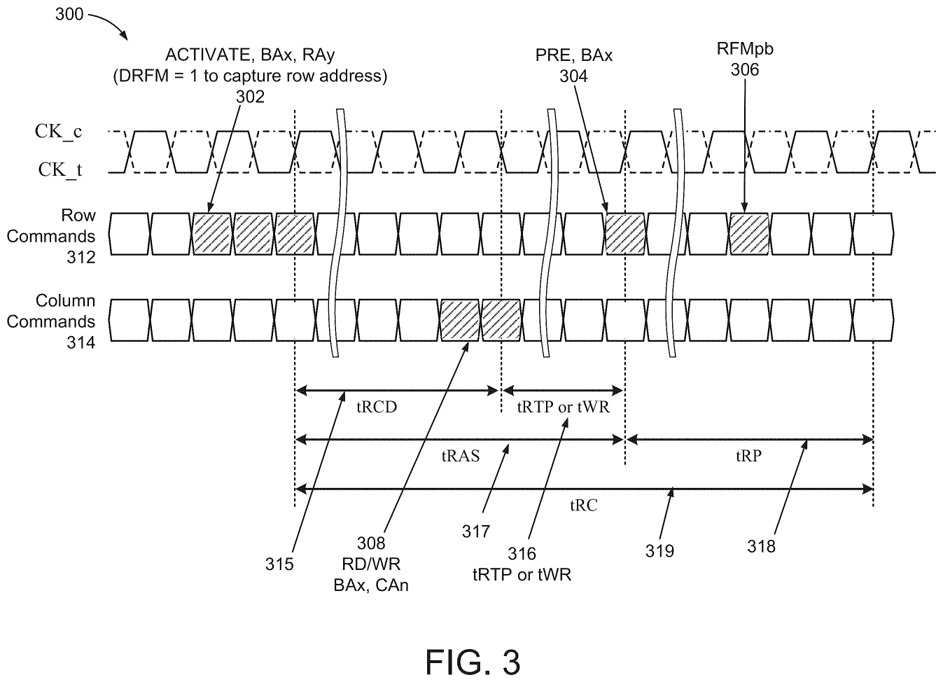

In an example, a field of an activate command is used as a DRFM flag, and the HBM DRAM is designed to recognize the DRFM flag (i.e., to capture a row address of the activate command upon a subsequent precharge command), such as described below with reference to FIG. 3.

FIG. 3 illustrates a timing diagram 300 of row commands 312 and column commands 314 for capturing a row address for a DRFM event based on a DRFM flag of an activate command, according to an example.

For the example of FIG. 3, the HBM DRAM is designed to capture a row address of the activate command when closing a bank, and to execute a DRFM event in response to subsequent refresh management control, if the DRFM flag is set in the activate command.

In FIG. 3, a host issues an activate command 302 with the DRFM flag set (e.g., set to 1), to instruct the HBM DRAM to open a target bank and target row based on a bank address BAx and a row address RAy of activate command 302. The host subsequently issues a precharge command (PRE) 304 to instruct the HBM DRAM to close the target bank. Since the DRFM flag was set in activate command 302, the DRAM captures the target row address RAy of activate command 302 when the HBM DRAM closes the target bank. Thereafter, the host issues a refresh management per bank command, RFMpb 306. Since to the DRFM flag was set in activate command 302, the DRAM interprets RFMpb 306 as a command to execute a DRFM event based on the captured row address.

In an example, the DRAM is designed to capture the row address of activate command 302 without a corresponding column command (e.g., read or write command). In another example, where the DRAM controller requires a corresponding column command, the host issues a column command 308.

In the example of FIG. 3, row commands 312 and column commands 314 conform to timing separations designated tRCD 315, tRTP/tWR 316, tRAS 317, tRP 318, and tRC 319, which may be based on a specification (e.g., a JEDEC specification).

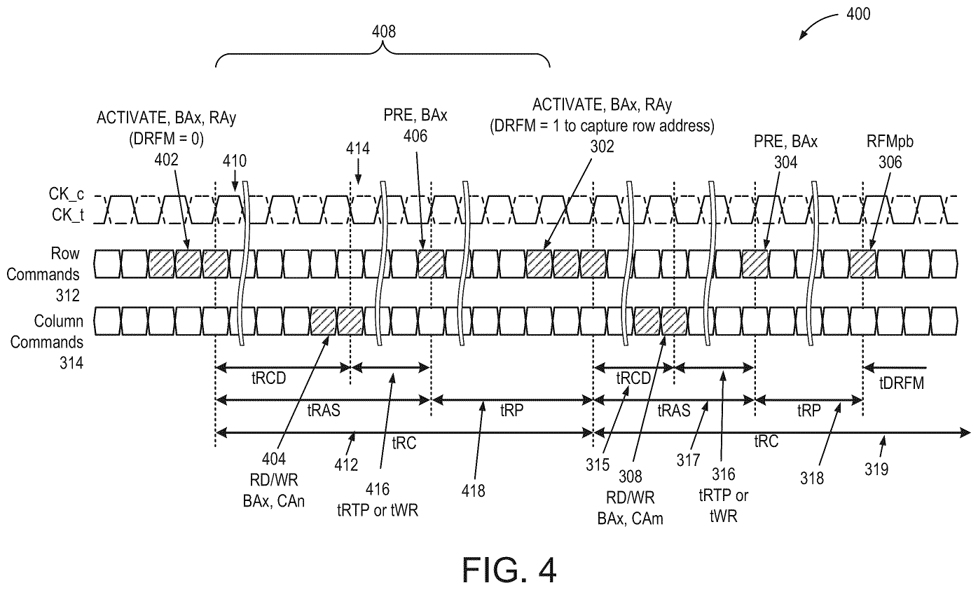

In the example of FIG. 3, the target bank is idle (i.e., closed) when the host issue the activate command 302. There may be situations in which the host decides to capture a row address of a currently open bank/row. In some other types of DRAM devices (i.e., non-HBM devices), if a host decides to initiate a row capture for a DRFM event while the target bank/row is open (i.e., after the host issues an activate command, but before the host issues a subsequent precharge command), the host sets a DRFM flag in a subsequent precharge command. Where the DRFM flag is provided in an activate command (e.g., activate command 302), the situation is not so simple, as described below with reference to FIG. 4.

FIG. 4 illustrates a timing diagram 400 of row commands 312 and column commands 314 for a situation in which the host decides to capture a row address of an open bank/row, according to an example. In FIG. 4, the host issues an activate command 402 to the target bank, with the DRFM flag un-set (e.g., set to 0), followed by a column command 404, and a precharge command 406. If the host decides to issue activate command 302 (i.e., with the DRFM flag set), while the target bank/row is open (i.e., within a time frame 408), the host will need wait until the DRAM closes the target bank/row in response to precharge control 406 (i.e., at the end of time tRC 412).

For example, if the host decides to capture the target row address at a time 410, the host will need to wait for nearly the duration of time tRC 412. If the host decides to capture the target row address at time 414, the host will need to wait for nearly the duration of a sum of time 416 (i.e., tRTP or tWR) and time tRP 418.

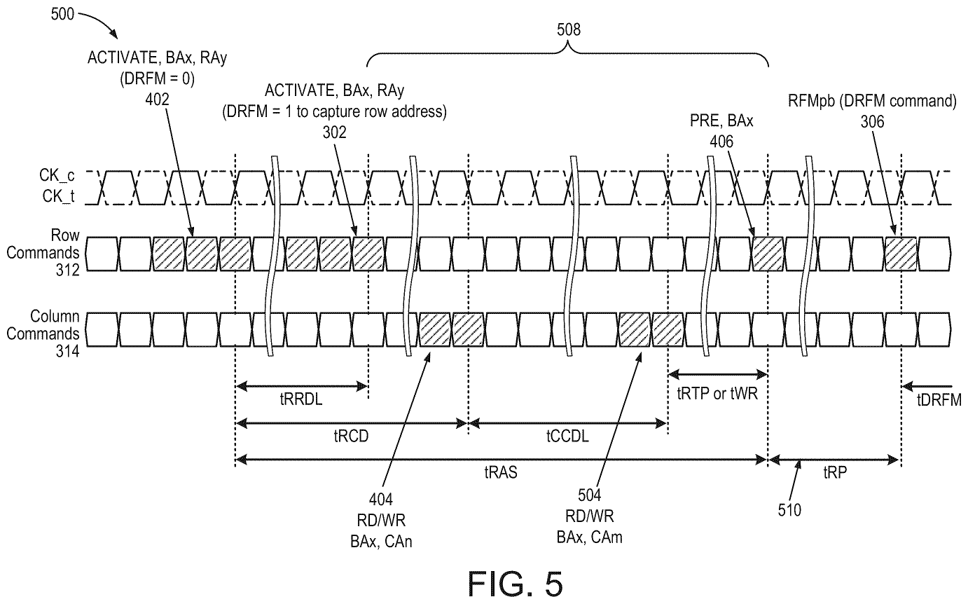

FIG. 5 illustrates a timing diagram 500 in which the HBM DRAM (e.g., a state machine of the HBM DRAM) is designed to process activate command 302 (i.e., with DRFM=1) while the target bank/row are open, without having to wait until the target bank/row are closed, according to an example.

In the example of FIG. 5, the host issues activate command 402 (i.e., with DRFM flag=0) to the target bank/row, followed by multiple column commands, 404 and 504, to the target bank/row, followed by PRE command 406. The host also issues activate command 302 (i.e., with DRFM flag=1) to the target bank/row while the target bank/row are open (i.e., prior to PRE command 406).

Based on activate command 302 (i.e., with DRFM flag=1), the HBM DRAM captures the target row address (e.g., when the DRAM closes the target bank/row in response to PRE command 406, or before). Thereafter, the HBM DRAM controller executes the DRFM event based on the captured row address in response to RFMpb command 306, such as described further above.

The example of FIG. 5 reduces the delay between when the host decides to capture the target row address, and the time that the DRAM captures the target row address, relative to the example of FIG. 4.

In the example of FIG. 5, the activate commands 302 and 402 are separated by time tRRDL. In an example, the host may issue activate command 302 anywhere within a time frame 508.

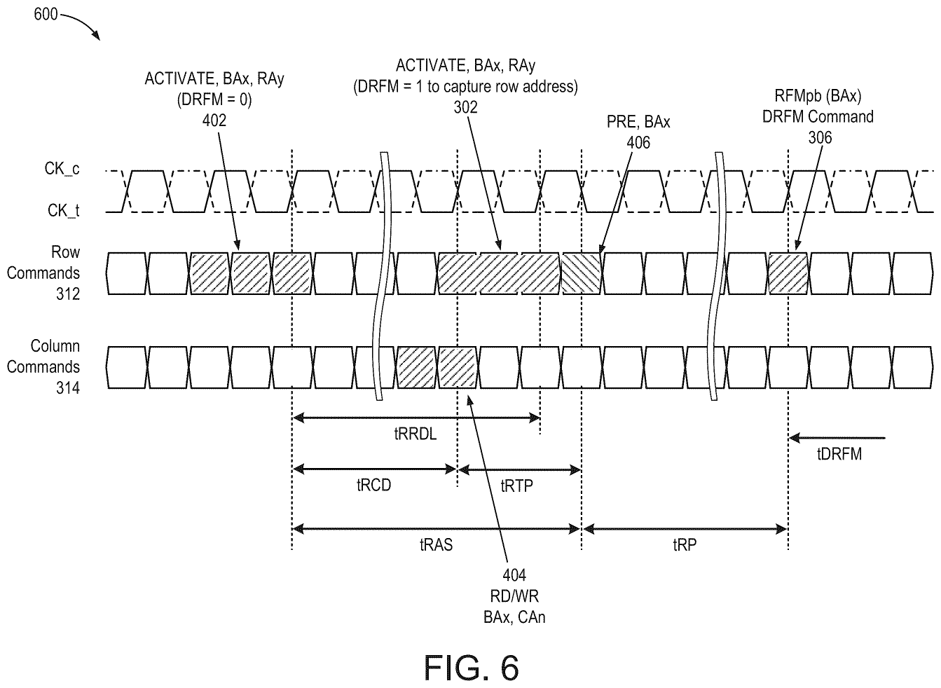

FIG. 6 illustrates a timing diagram 600 in which the HBM DRAM is designed to process activate command 302 (i.e., with DRFM=1) while the target bank/row are open, such as described above with reference to FIG. 5, where activate command 302 overlaps with column command 404. according to an example.

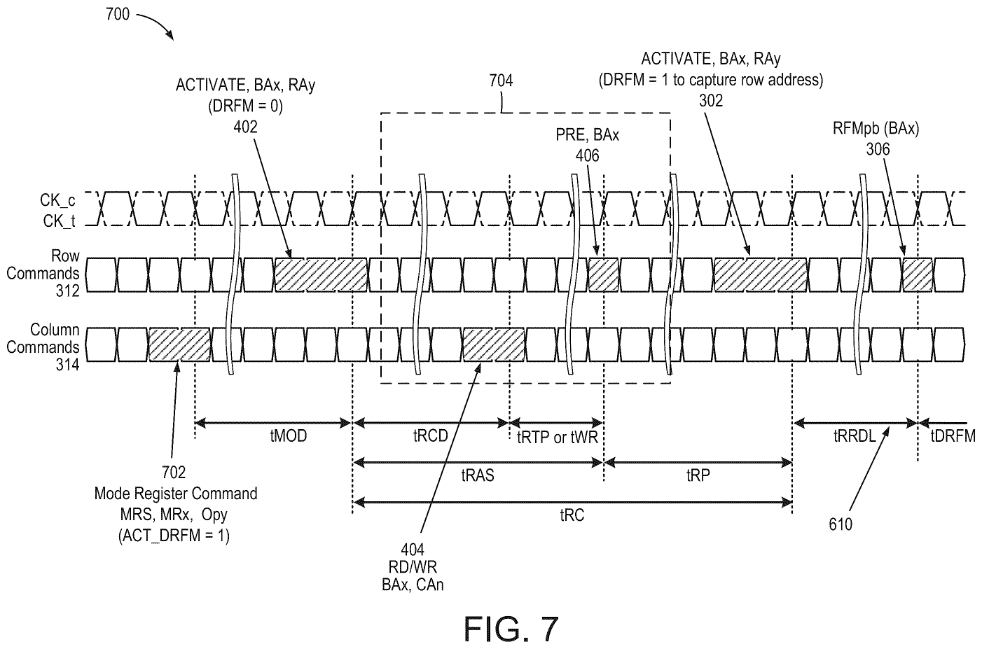

FIG. 7 illustrates a timing diagram 700 in which the HBM DRAM is designed to process activate command 302 (i.e., with DRFM=1) while the target bank/row are closed, without opening the target bank/row, according to an example. For the example of FIG. 7, the HBM DRAM is designed to capture a target row address (e.g., prior to or upon a subsequent RFMpb command) without opening the target bank/row (i.e., to suppress or override opening of the target bank/row), when the host issues an activate command having the DRFM flag=1 (e.g., activate command 302), and a mode register is set.

In FIG. 7, the host issues a mode register command 702 to instruct the HBM DRAM to set a mode register ACT_DRFM to 1. Thereafter, the host may issue activate command 402 (i.e. DRFM flag=0), followed by column command 404, and precharge command 406, such as described further above.

Thereafter, the host issues activate command 302 (i.e., DRFM flag=1), to capture a target row address specified in activate command 302. The target address of activate command 302 may be the same target row address of activate command 402, or a different target row address. (The host may decide to capture the target row address within a time frame 704). Since mode register ACT_DRFM is set to 1 (i.e., by mode register command 702), the DRAM captures the target row address specified in activate command 302, without opening the target bank/row. Thereafter, the HBM DRAM controller executes the DRFM event based on the captured row address in response to RFMpb command 306, such as described further above.

In the example of FIG. 7, the host does need to issue a precharge command or an auto precharge (AP) command. Since the target bank/row is not opened, and there is no need for a precharge/AP, power consumption is reduced.

Further in the example of FIG. 7, delay tRP 510 (FIG. 5) between PRE command 406 and RFMpb 306, is avoided. Instead, there is a delay of tRRDL 710 between activate command 302 and RFMpb 306.

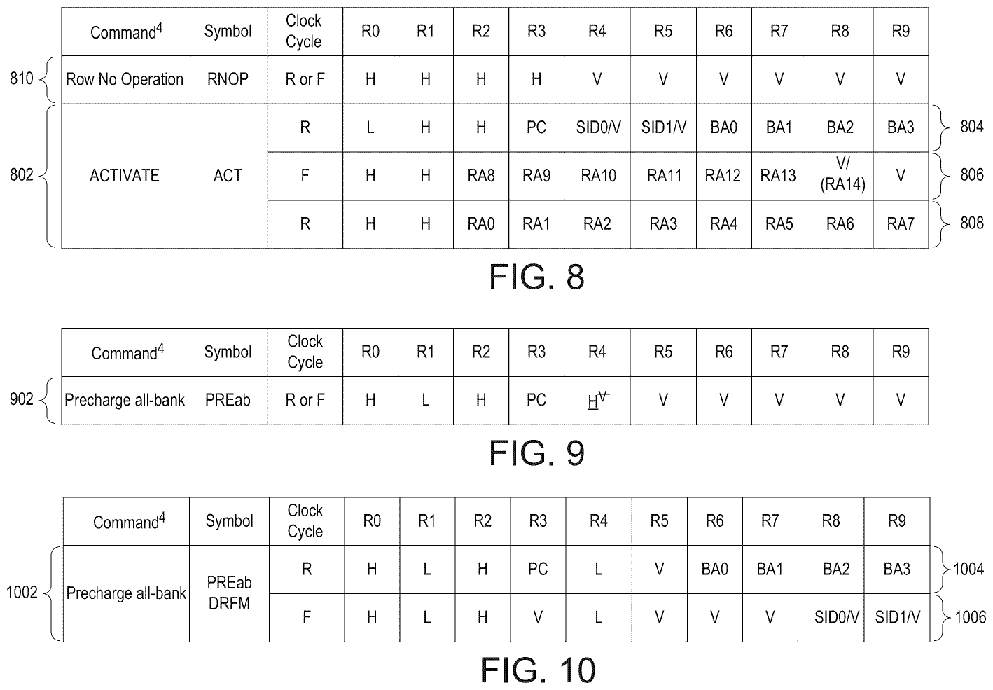

FIG. 8 illustrates an activate command 802 that has a field for a DRFM flag, according to an example. Activate command 802 includes command encoding fields R0, R1, and R2, and address fields R3-R9. In the example of FIG. 8, activate command 802 is a 3-unit interval (3-UI) command that includes first, second, and third UIs 804, 806, and 808, respectively. An address field (e.g., address field R8 of second UI 806) may be used as a DRFM field.

In another example, a precharge command includes a DRFM field, such as described below with reference to FIGS. 9 and 10.

FIG. 9 illustrates a precharge per-bank command, PREbp 902 formatted in accordance with a HBM standard. PREbp 902 is illustrated as a half cycle (i.e., 1-UI) command that can be issued on a rising or falling edge of a clock. Address fields R3-R9 of PREbp 902 include a pseudo-channel field R3, stack identifier (SID) fields R4 and R5 (which serve as bank address bits for command execution), and bank address fields R6 through R9. As illustrated in FIG. 9, all address fields of PREbp 902 are occupied, such that there is no room for a DRFM flag.

In an example, PREbp 902 is converted into a multi-cycle command to provide additional fields, one of which is reserved for a DRFM flag. In this example, when the DRFM flag is set, a HBM DRAM captures an address of a target row specified in the converted PREbp 902, as the HBM DRAM closes the target row.

In another example, a 2-UI (i.e., single cycle) precharge command includes a DRFM flag, such as described below with reference to FIG. 10. A 2-UI precharge command may preferable to a multi-cycle command.

FIG. 10 illustrates a 2-UI (i.e., single cycle) precharge per-bank command, PREbp_DRFM 1002, that includes a field for a DRFM flag, according to an example. In a first UI 1004 of PREbp_DRFM 1002, pseudo-channel field R3 is used as a pseudo-channel flag. In a second UI 1006 of PREbp_DRFM 1002, pseudo-channel field R3 is used as a DRFM field. When the DRFM flag is set, a HBM DRAM captures an address of a target row specified in address fields of PREbp 1002, as the HBM DRAM closes the target row. When the DRFM flag is not set, the HBM DRAM closes the target row without capturing the address of the target row.

PREbp 1002 may represent a modified version of a precharge per-bank (PREpb) command. In the example of FIG. 10, command encoding fields R0, R1, and R2 of first and second portions 1004 and 1006, are encoded high, low, high, respectively. Whereas in in FIG. 9, command encoding fields R0, R1, and R2 of PREpb 902 are encoded high, low, low, respectively.

In FIG. 8, 3^{rd} UI 808 is issued on a rising edge of a clock. In FIG. 9, PREpb 902 can be issued on a rising edge of a clock or a falling edge of the clock. PREpb 902 can thus be on a falling edge immediately after the 3^{rd} UI of activate command 802. In FIG. 10, first UI 1004 of PREpb_DRFM 1002 can be issued on a rising edge of a clock. For the example of FIG. 10, a host may issue a no operation (RNOP) command 810 (FIG. 8) on the falling edge of the clock, immediately 3^{rd} UI 806 of activate command 802, and first UI 1004 of PREpb_DRFM 1002 can be issued as early as the next rising edge of the clock.

In another example, a field of a precharge all banks (PREab) command may be used as a DRFM flag (e.g., address field R4). In this example, when the DRFM flag is set, a HBM DRAM captures a target row address specified in the PREab command, as the HBM DRAM closes the target row.

In another example, a field of a refresh per-bank (RFpb) command is used as a DRFM flag. In this example, when the DRFM flag is set, a HBM DRAM captures a target row address specified in the RRpb command, as the HBM DRAM closes the target row.

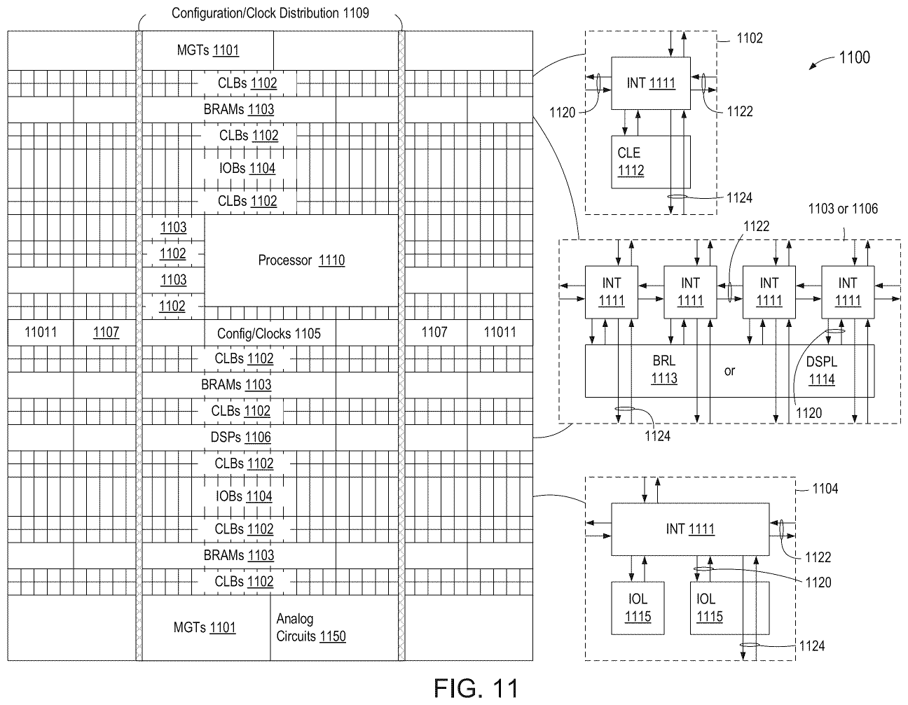

IC device 100, may include one or more of a variety of types of configurable circuit blocks, such as described below with reference to FIG. 11. FIG. 11 is a block diagram of configurable circuitry 1100, including an array of configurable or programmable circuit blocks or tiles, according to an embodiment. The example of FIG. 11 may represent a field programmable gate array (FPGA) and/or other IC device(s) that utilizes configurable interconnect structures for selectively coupling circuitry/logic elements, such as complex programmable logic devices (CPLDs).

In the example of FIG. 11, the tiles include multi-gigabit transceivers (MGTs) 1101, configurable logic blocks (CLBs) 1102, block random access memory (BRAM) 1103, input/output blocks (IOBs) 1104, configuration and clocking logic (Config/Clocks) 1105, digital signal processing (DSP) blocks 1106, specialized input/output blocks (I/O) 1107 (e.g., configuration ports and clock ports), and other programmable logic 1108, which may include, without limitation, digital clock managers, analog-to-digital converters, and/or system monitoring logic. The tiles further includes a dedicated processor 1110.

One or more tiles may include a programmable interconnect element (INT) 1111 having connections to input and output terminals 1120 of a programmable logic element within the same tile and/or to one or more other tiles. A programmable INT 1111 may include connections to interconnect segments 1122 of another programmable INT 1111 in the same tile and/or another tile(s). A programmable INT 1111 may include connections to interconnect segments 1124 of general routing resources between logic blocks (not shown). The general routing resources may include routing channels between logic blocks (not shown) including tracks of interconnect segments (e.g., interconnect segments 1124) and switch blocks (not shown) for connecting interconnect segments. Interconnect segments of general routing resources (e.g., interconnect segments 1124) may span one or more logic blocks. Programmable INTs 1111, in combination with general routing resources, may represent a programmable interconnect structure.

A CLB 1102 may include a configurable logic element (CLE) 1112 that can be programmed to implement user logic. A CLB 1102 may also include a programmable INT 1111.

A BRAM 1103 may include a BRAM logic element (BRL) 1113 and one or more programmable INTs 1111. A number of interconnect elements included in a tile may depends on a height of the tile. A BRAM 1103 may, for example, have a height of five CLBs 1102. Other numbers (e.g., four) may also be used.

A DSP block 1106 may include a DSP logic element (DSPL) 1114 in addition to one or more programmable INTs 1111. An IOB 1104 may include, for example, two instances of an input/output logic element (IOL) 1115 in addition to one or more instances of a programmable INT 1111. An I/O pad connected to, for example, an I/O logic element 1115, is not necessarily confined to an area of the I/O logic element 1115.

In the example of FIG. 11, config/clocks 1105 may be used for configuration, clock, and/or other control logic. Vertical columns 1109 may be used to distribute clocks and/or configuration signals.

A logic block (e.g., programmable of fixed-function) may disrupt a columnar structure of configurable circuitry 1100. For example, processor 1110 spans several columns of CLBs 1102 and BRAMs 1103. Processor 1110 may include one or more of a variety of components such as, without limitation, a single microprocessor to a complete programmable processing system of microprocessor(s), memory controllers, and/or peripherals.

In FIG. 11, configurable circuitry 1100 further includes analog circuits 1150, which may include, without limitation, one or more analog switches, multiplexers, and/or de-multiplexers. Analog switches may be useful to reduce leakage current.

FIG. 11 is provided for illustrative purposes. Configurable circuitry 1100 is not limited to numbers of logic blocks in a row, relative widths of the rows, numbers and orderings of rows, types of logic blocks included in the rows, relative sizes of the logic blocks, illustrated interconnect/logic implementations, or other example features of FIG. 11.

In the preceding, reference is made to examples presented in this disclosure. However, the scope of the present disclosure is not limited to specific described examples. Instead, any combination of the described features and elements, whether related to different examples or not, is contemplated to implement and practice contemplated examples. Furthermore, although examples disclosed herein may achieve advantages over other possible solutions or over the prior art, whether or not a particular advantage is achieved by a given example is not limiting of the scope of the present disclosure. Thus, the preceding aspects, features, examples and advantages are merely illustrative and are not considered elements or limitations of the appended claims except where explicitly recited in a claim(s).

As will be appreciated by one skilled in the art, the examples disclosed herein may be embodied as a system, method or computer program product. Accordingly, aspects may take the form of an entirely hardware example, an entirely software example (including firmware, resident software, micro-code, etc.) or an example combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to examples presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit device, comprising:
a high-bandwidth memory (HBM) device comprising a stack of dynamic random access memory (DRAM) dies, wherein the DRAM dies comprise respective banks of memory cells and control circuitry configured to,
receive a command directed to a bank of the DRAM dies, wherein the command comprises an address of a target row of memory cells within the bank and a directed refresh management (DRFM) flag field, wherein the command further comprises one or more of an activate command and a first precharge command, and
capture the address of the target row of memory cells if the DRFM flag field is set.

2. The integrated circuit device of claim 1, wherein the command comprises the activate command, and wherein the control circuitry is further configured to:
open the bank based on the activate command;
receive a column command directed to the target row of memory cells, while the bank is open;
execute the column command on the target row of memory cells while the bank is open; and
close the bank based on a second precharge command directed to the bank, subsequent to executing the column command.

3. The integrated circuit device of claim 1, wherein the control circuitry is further configured to:
capture the address of the target row of memory cells if the DRFM flag field is set, without opening the bank.

4. The integrated circuit device of claim 1, wherein the control circuitry is further configured to:
execute a directed refresh management (DRFM) event based on the captured address of the target row of memory cells.

5. The integrated circuit device of claim 4, wherein the control circuitry is further configured to:
execute the DRFM event based further on a refresh management per page command directed to the address of the bank.

6. The integrated circuit device of claim 1, wherein the control circuitry is further configured to:
receive the command while the bank is open.

7. The integrated circuit device of claim 6, wherein the control circuitry is further configured to:
receive a column command directed to the target row of memory cells while the bank is open; and
execute the column command on the target row of memory cells while the bank is open.

8. The integrated circuit device of claim 6, wherein the control circuitry is further configured to:
capture the address of the target row of memory cells if the DRFM flag is set, without executing a column command on the target row of memory cells.

9. The integrated circuit device of claim 1, wherein the control circuitry is further configured to:
capture the address of the target row of memory cells if the DRFM flag is set and a mode register bit is set.

10. The integrated circuit device of claim 9, wherein the control circuitry is further configured to:
set the mode register bit based on a mode register command from a host device.

11. The integrated circuit device of claim 1, wherein the command comprises the precharge command, and wherein the precharge command comprises one of:
a multi-cycle precharge per-bank command; and
a single-cycle precharge command in which a pseudo-channel field of a unit interval of the single-cycle precharge command serves as the DRFM flag field.

12. A system, comprising:
a host device configured to,
interface with a high-bandwidth memory (HBM) device that comprises a stack of dynamic random access memory (DRAM) dies, wherein the DRAM dies comprise respective banks of memory cells, and
issue a first activate command directed to a bank of the DRAM dies, wherein the first activate command comprises an address of the bank, an address of a target row of memory cells within the bank, and a directed refresh management (DRFM) flag field.

13. The system of claim 12, wherein the host device is further configured to:
issue a first precharge command to close the bank;
issue the first activate command a predetermined amount of time subsequent to issuing the first precharge command; and
issue a second precharge command to close the bank, subsequent to issuing the first precharge command.

14. The system of claim 13, wherein the host device is further configured to:
issue a column command directed to the bank subsequent to issuing the first activate command; and
issue the second precharge command subsequent to issuing the column command.

15. The system of claim 13, wherein the host device is further configured to:
issue the second precharge command to close the bank, subsequent to issuing the first precharge command, without issuing an intervening column command directed to the target row of memory cells.

16. The system of claim 12, wherein the host device is further configured to:
issue a second activate command with the DRFM flag field un-set; and
issue the first activate command directed to the bank, while the bank is open.

17. The system of claim 16, wherein the host device is further configured to:
issue a column command directed to the target row of memory cells while the bank is open, wherein the column command is associated with the first activate command; and
issue a precharge command to close the bank, subsequent to issuing the column command, without issuing a column command associated with the second activate command.

18. The system of claim 12, wherein the host device is further configured to:
issue a mode register command to the HBM device to set a mode register bit of the HBM device to signal that the address of the target row of memory is to be captured.

19. A system, comprising:
a host device configured to interface with a high-bandwidth memory (HBM) device that includes a stack of dynamic random access memory (DRAM) dies, wherein the DRAM dies comprise respective banks of memory cells, and wherein the host device is configured to:
issue a precharge command directed to a bank of the memory cells, wherein the precharge command comprises an address of a target row of memory cells of the bank and a DRFM flag field, wherein the precharge command comprises one of,
a multi-cycle precharge per-bank command, and
a single-cycle precharge command in which a pseudo-channel field of a unit interval of the single-cycle precharge command serves as the DRFM flag field.
